(19) United States
(12) Patent Application Publication
(10) Pub. No.: US 2011/0029209 A1
(43) Pub. Date: Feb. 3, 2011

(54) CONTROL DEVICE AND CONTROL METHOD FOR CONTINUOUSLY VARIABLE TRANSMISSION

(75) Inventors: Kunio Hattori, Toyota-shi (JP); Shinya Toyoda, Nisshin-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi, Aichi-ken (JP)

(21) Appl. No.: 12/922,604

(22) PCT Filed: Mar. 10, 2009
(86) PCT No.: PCT/JP2009/054532

§ 371 Date: Sep. 14, 2010

(30) Foreign Application Priority Data
Apr. 15, 2008 (JP) 2008-105756

(51) Int. Cl. F16H 59/42; F16H 59/72

(52) U.S. Cl. 701/58; 701/51

(57) ABSTRACT

An ECU executes a program including the steps of starting restriction of a target revolution number NINT of a primary pulley revolution number NIN to a limit value NGRD or lower and canceling restriction of the target revolution number NINT to the limit value NGRD or lower when a condition that the target revolution number NINT set by using a map is lower than the limit value NGRD is satisfied.

### TECHNICAL FIELD

The present invention relates to a control device and a control method for a continuously variable transmission, and particularly to a technique for restricting a target input shaft revolution number of a continuously variable transmission to a limit value or lower.

### BACKGROUND ART

A continuously variable transmission (CVT) such as a belt-type continuously variable transmission, in which a primary pulley and a secondary pulley are coupled to each other using a metal belt and continuous shift change is achieved by varying a width of each of the pulleys, has conventionally been known. In a vehicle incorporating this belt-type continuously variable transmission, a width of the pulley is varied by supplying a hydraulic cylinder of the primary pulley with hydraulic oil or draining the hydraulic oil from the hydraulic cylinder so that shift change is achieved.

A temperature of hydraulic oil used in a continuously variable transmission may be raised by heat generated from the continuously variable transmission. Viscosity of the hydraulic oil may vary in accordance with the temperature. Therefore, when the temperature of the hydraulic oil is excessive, controllability of the continuously variable transmission may deteriorate. Therefore, increase in the temperature of the hydraulic oil should be restricted.

Japanese Patent Laying-Open No. 9-217824 (Patent Document 1) discloses a shift change control device in a continuously variable transmission, for controlling shift change to set such a gear ratio as lowering a revolution number on an input side (an input shaft revolution number) to a set revolution number when the continuously variable transmission is in a manual range, the temperature of the hydraulic oil is equal to or higher than a first set value, and the revolution number on the input side is equal to or higher than the set revolution number. In addition, Patent Document 1 describes gradual increase in a maximum input revolution number in returning to normal control.

According to the shift change control device described in this publication, the revolution number on the input side is limited to the set revolution number or lower and hence increase in the temperature of the hydraulic oil can be prevented.

### Patent Document 1: Japanese Patent Laying-Open No. 9-217824

### DISCLOSURE OF THE INVENTION

### Problems to be Solved by the Invention

In Japanese Patent Laying-Open No. 9-217824, however, when the temperature of the hydraulic oil lowers and control returns to normal control, a target input shaft revolution number of the continuously variable transmission may increase even if a running state remains the same. Therefore, the continuously variable transmission is down-shifted regardless of the running state, which may make a driver feel uncomfortable.

The present invention was made to solve the above-described problems, and an object thereof is to lessen driver's uncomfortable feeling.

### Means for Solving the Problems

A control device for a continuously variable transmission according to one aspect includes a setting unit that sets a target input shaft revolution number of the continuously variable transmission, a restriction unit that restricts the target input shaft revolution number to a predetermined limit value or lower, a control unit that controls an input shaft revolution number of the continuously variable transmission to attain the target input shaft revolution number, and a canceling unit that cancels restriction of the target input shaft revolution number to the limit value or lower when a condition that the target input shaft revolution number is lower than the limit value is satisfied,

According to this configuration, the target input shaft revolution number is restricted to the limit value or lower. The input shaft revolution number of the continuously variable transmission is controlled to attain the target input shaft revolution number. Thus, for example when the temperature of the hydraulic oil supplied to the continuously variable transmission is high, an amount of heat generation in the continuously variable transmission can be restricted by lowering the target input shaft revolution number. Therefore, the temperature of the hydraulic oil can be maintained in an appropriate state. When the condition that the target input shaft revolution number is lower than the limit value is satisfied, restriction of the target input shaft revolution number to the limit value or lower is canceled. Thus, the target input shaft revolution number immediately before cancellation of restriction of the target input shaft revolution number to the limit value or lower can substantially be equal to the target input shaft revolution number immediately after cancellation. Therefore, restriction of the target input shaft revolution number to the limit value or lower can be canceled without down-shifting. Consequently, a control device for a continuously variable transmission, capable of lessening driver's uncomfortable feeling, can be provided.

Preferably, the control device for a continuously variable transmission further includes a detection unit that detects a temperature of hydraulic oil supplied to the continuously variable transmission. When a condition that the temperature of the hydraulic oil is higher than a threshold value is satisfied, the restriction unit restricts the target input shaft revolution number to the limit value or lower. When a condition that the temperature of the hydraulic oil is equal to or lower than the threshold value in addition to the condition that the target input shaft revolution number is lower than the limit value is satisfied, the canceling unit restricts the target input shaft revolution number to the limit value or lower.

According to this configuration, when the condition that the temperature of the hydraulic oil supplied to the continuously variable transmission is higher than the threshold value is satisfied, the target input shaft revolution number is restricted to the limit value or lower. Thus, when controllability of the continuously variable transmission may deteriorate, an amount of heat generation in the continuously variable transmission can be restricted by lowering the target input shaft revolution number. Therefore, controllability of the continuously variable transmission can be less likely to deteriorate. When the condition that the temperature of the hydraulic oil is equal to or lower than the threshold value in addition to the condition that the target input shaft revolution number is lower than the limit value is satisfied, restriction of the target input shaft revolution number to the limit value or lower is canceled. Thus, while controllability of the continuously variable transmission is good, restriction of the target input shaft revolution number to the limit value or lower can be canceled.

A control device for a continuously variable transmission according to another aspect is a control device for a continuously variable transmission controlled in a manner defined for each of a plurality of shift ranges in a vehicle provided with an accelerator pedal. This control device includes an accelerator pedal opening angle detection unit that detects an accelerator pedal opening angle, a selection unit that selects a shift range of the continuously variable transmission, a first setting unit that sets a target input shaft revolution number of the continuously variable transmission to be lower as the accelerator pedal opening angle is smaller within a range equal to or higher than a first lower limit value when a first shift range is selected, a second setting unit that sets the target input shaft revolution number within a range equal to or higher than a second lower limit value higher than the first lower limit value when a second shift range is selected, a restriction unit that restricts the target input shaft revolution number to a predetermined limit value or lower, a control unit that controls an input shaft revolution number of the continuously variable transmission to attain the target input shaft revolution number, and a canceling unit that cancels restriction of the target input shaft revolution number to the limit value or lower when a condition that the shift range was changed from the second shift range to the first shift range is satisfied while the accelerator pedal opening angle is equal to or smaller than a predetermined value. The first setting unit sets the target input shaft revolution number to be lower than the limit value when the accelerator pedal opening angle is equal to or smaller than the predetermined value.

According to this configuration, when the first shift range is selected, the target input shaft revolution number of the continuously variable transmission is set to be lower as the accelerator pedal opening angle is smaller within the range equal to or higher than the first lower limit value. When the second shift range is selected, the target input shaft revolution number is set to be lower as the accelerator pedal opening angle is smaller within the range equal to or higher than the second lower limit value higher than the first lower limit value. The target input shaft revolution number is restricted to the limit value or lower. The input shaft revolution number of the continuously variable transmission is controlled to attain the target input shaft revolution number. Thus, for example when the temperature of the hydraulic oil supplied to the continuously variable transmission is high, an amount of heat generation in the continuously variable transmission can be restricted by lowering the target input shaft revolution number. Therefore, the temperature of the hydraulic oil can be maintained in an appropriate state, In the first shift range, when the accelerator pedal opening angle is equal to or smaller than the predetermined value, the target input shaft revolution number is set to be lower than the limit value. Then, when the condition that the shift range was changed from the second shift range to the first shift range is satisfied while the accelerator pedal opening angle is equal to or smaller than the predetermined value, restriction of the target input shaft revolution number to the limit value or lower is canceled, Thus, restriction of the target input shaft revolution number to the limit value or lower can be canceled without down-shifting. Consequently, a control device for a continuously variable transmission, capable of lessening driver's uncomfortable feeling, can be provided.

Preferably, the control device for a continuously variable transmission further includes a temperature detection unit that detects a temperature of hydraulic oil supplied to the continuously variable transmission. When a condition that the temperature of the hydraulic oil is higher than a threshold value is satisfied, the restriction unit restricts the target input shaft revolution number to the limit value or lower. When a condition that the temperature of the hydraulic oil is equal to or lower than the threshold value in addition to the condition that the shift range was changed from the second shift range to the first shift range is satisfied while the accelerator pedal opening angle is equal to or smaller than the predetermined value, the canceling unit cancels restriction of the target input shaft revolution number to the limit value or lower.

According to this configuration, when the condition that the temperature of the hydraulic oil supplied to the continuously variable transmission is higher than the threshold value is satisfied, the target input shaft revolution number is restricted to the limit value or lower. Thus, when controllability of the continuously variable transmission may deteriorate, an amount of heat generation in the continuously variable transmission can be restricted by lowering the target input shaft revolution number. Therefore, controllability of the continuously variable transmission can be less likely to deteriorate. When the condition that the temperature of the hydraulic oil is equal to or lower than the threshold value in addition to the condition that the shift range was changed from the second shift range to the first shift range is satisfied while the accelerator pedal opening angle is equal to or smaller than the predetermined value, restriction of the target input shaft revolution number to the limit value or lower is canceled. Thus, while controllability of the continuously variable transmission is good, restriction of the target input shaft revolution number to the limit value or lower can be canceled.

### Effects of the Invention

According to the present invention, driver's uncomfortable feeling can be lessened.

### BRIEF DESCRIPTION OF THE DRAWINGS

FIG. 1 is a diagram showing a drive device of a vehicle.

FIG. 2 is a control block diagram of an ECU.

FIG. 3 is a diagram showing a shift lever.

FIG. 4 is a diagram (No. 1) showing a hydraulic control circuit.

FIG. 5 is a diagram (No. 2) showing a hydraulic control circuit.

FIG. 6 is a diagram (No. 3) showing a hydraulic control circuit.

FIG. 7 is a functional block diagram of the ECU.

FIG. 8 is a diagram showing a target revolution number NINT in a “D” range.

FIG. 9 is a diagram showing a target revolution number NINT in an “SD” range.

FIG. 10 is a diagram showing a target revolution number NINT in a “B” range.

FIG. 11 is a diagram showing a limit value NGRD.

FIG. 12 is a flowchart showing a control structure of a program executed by the ECU.

### DESCRIPTION OF THE REFERENCE SIGNS

100 drive device; 200 engine; 300 torque converter; 310 oil pump; 400 forward and backward movement switching device; 402 sun gear; 404 carrier; 406 forward clutch; 408 ring gear; 410 reverse brake; 500 belt-type continuously variable transmission; 502 input shaft; 504 primary pulley; 506 output shaft; 508 secondary pulley; 510 belt; 600 reduction gear; 700 differential gear mechanism; 800 driving wheel; 900 ECU; 902 engine revolution number sensor; 904 turbine revolution number sensor; 906 vehicle speed sensor; 908 throttle position sensor; 910 coolant temperature sensor; 912 oil temperature sensor; 914 accelerator position sensor; 916 foot brake switch; 918 position sensor; 920 shift lever; 922 primary pulley revolution number sensor; 924 secondary pulley revolution number sensor; 930 setting unit; 932 restriction unit; 934 canceling unit; 936 control unit; 1000 electronic throttle valve; 1100 fuel injection apparatus; 1200 ignition apparatus; 2000 hydraulic control circuit; 2002 line pressure oil passage; 2100 primary regulator valve; 2200 SLT linear solenoid valve; 2210 SLS linear solenoid valve; 2310 modulator valve (1); 2330 modulator valve (3); 2340 modulator valve (4); 2312 pressure sensor; 2400 control valve; 2510 shift controlling duty solenoid (1); 2520 shift controlling duty solenoid (2); 2600 manual valve; 2710 ratio control valve (1); 2720 ratio control valve (2); and 2800 bypass control valve.

### BEST MODES FOR CARRYING OUT THE INVENTION

An embodiment of the present invention will be described hereinafter with reference to the drawings. In the description below, the same elements have the same reference characters allotted and their label and function are also identical. Therefore, detailed description thereof will not be repeated.

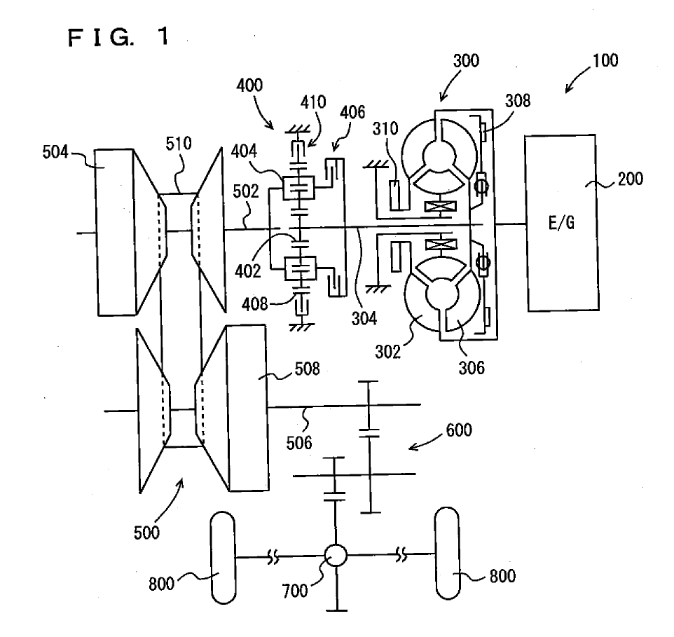

A vehicle incorporating a control device according to the present embodiment will be described with reference to FIG. 1. Output from an engine 200 in a drive device 100 mounted on this vehicle is input to a continuously variable transmission 500 through a torque converter 300 and a forward and backward movement switching device 400. Output from continuously variable transmission 500 is transmitted to a reduction gear 600 and a differential gear mechanism 700 and distributed to left and right driving wheels 800. Drive device 100 is controlled by an ECU (Electronic Control Unit) 900 which will be described later.

Torque converter 300 is constituted of a pump impeller 302 coupled to a crankshaft of engine 200 and a turbine wheel 306 coupled to forward and backward movement switching device 400 with a turbine shaft 304 being interposed. A lock-up clutch 308 is provided between pump impeller 302 and turbine wheel 306. Lock-up clutch 308 is engaged or disengaged as a result of switching of hydraulic oil pressure supply to an oil chamber on an engagement side and an oil chamber on a disengagement side.

With lock-up clutch 308 completely engaged, pump impeller 302 and turbine wheel 306 are caused to integrally rotate. A mechanical oil pump 310 for generating a hydraulic oil pressure for controlling shift change of continuously variable transmission 500, generating a belt holding pressure or supplying the hydraulic oil for lubrication to each part is provided in pump impeller 302.

Forward and backward movement switching device 400 is formed of a double-pinion-type planetary gear mechanism. Turbine shaft 304 of torque converter 300 is coupled to a sun gear 402. An input shaft 502 of continuously variable transmission 500 is coupled to a carrier 404. Carrier 404 and sun gear 402 are coupled to each other through a forward clutch 406. A ring gear 408 is fixed to a housing with a reverse brake 410 being interposed. Forward clutch 406 and reverse brake 410 are caused to be in friction engagement by a hydraulic cylinder. An input revolution number of forward clutch 406 is equal to a revolution number of turbine 304, that is, a turbine revolution number NT.

With forward clutch 406 engaged and reverse brake 410 disengaged, forward and backward movement switching device 400 enters a forward engagement state. In this state, forward driving force is transmitted to continuously variable transmission 500. With reverse brake 410 engaged and forward clutch disengaged, forward and backward movement switching device 400 enters a backward engagement state. In this state, input shaft 502 is caused to rotate in a reverse direction with respect to turbine shaft 304. Thus, backward driving force is transmitted to continuously variable transmission 500. With forward clutch 406 and reverse brake 410 both disengaged, forward and backward movement switching device 400 enters a neutral state in which transmission of motive power is cut off.

Continuously variable transmission 500 is constituted of a primary pulley 504 provided on input shaft 502, a secondary pulley 508 provided on an output shaft 506, and a belt 510 looped over these pulleys. Motive power is transmitted, using friction force between each pulley and belt 510.

Each pulley is implemented by a hydraulic cylinder so that its groove width is variable. As the hydraulic oil pressure of the hydraulic cylinder of primary pulley 504 is controlled, a groove width of each pulley is varied. Thus, a diameter of a loop of belt 510 is changed and hence a gear ratio GR a primary pulley revolution number NIN/a secondary pulley revolution number NOUT) is continuously varied. It is noted that a chain or toroidal continuously variable transmission may be employed instead of belt-type continuously variable transmission 500.

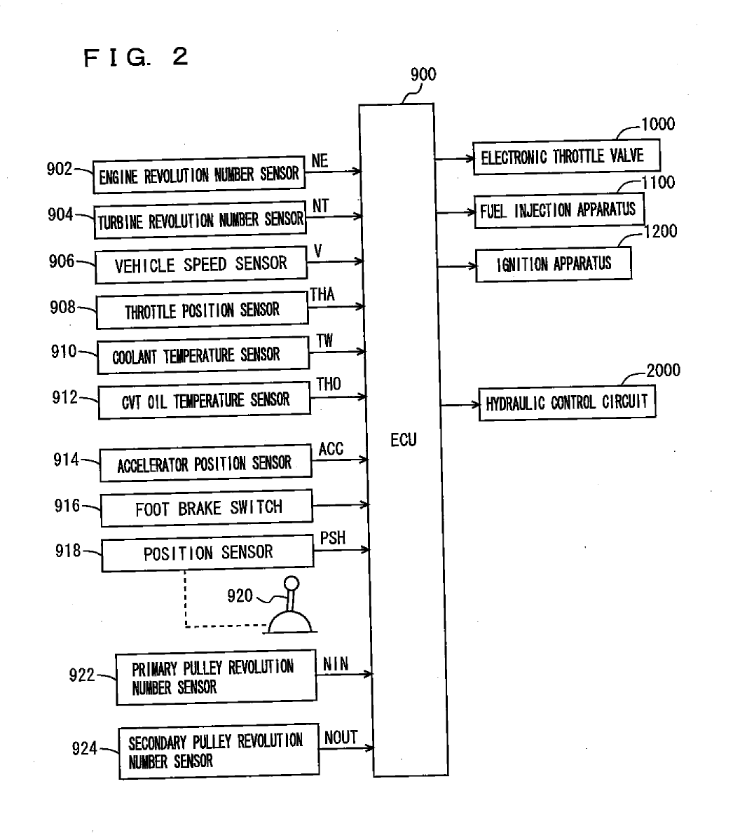

As shown in FIG. 2, an engine revolution number sensor 902, a turbine revolution number sensor 904, a vehicle speed sensor 906, a throttle position sensor 908, a coolant temperature sensor 910, an oil temperature sensor 912, an accelerator position sensor 914, a foot brake switch 916, a position sensor 918, a primary pulley revolution number sensor 922, and a secondary pulley revolution number sensor 924 are connected to ECU 900.

Engine revolution number sensor 902 detects a revolution number (engine revolution number) NE of engine 200. Turbine revolution number sensor 904 detects a revolution number (turbine revolution number) NT of turbine shaft 304. Vehicle speed sensor 906 detects .a vehicle speed V. Throttle position sensor 908 detects a position THA of an electronic throttle valve. Coolant temperature sensor 910 detects a temperature TW of a coolant for engine 200. Oil temperature sensor 912 detects a temperature THO of the hydraulic oil (hereinafter also referred to as the oil temperature) used for actuation of continuously variable transmission 500. Accelerator position sensor 914 detects an opening angle of an accelerator pedal ACC. Foot brake switch 916 detects whether a foot brake has been operated or not.

Position sensor 918 detects a position PSH of a shift lever 920 by determining whether a contact point provided at a position corresponding to a shift position is ON or OFF. Depending on position PSH of shift lever 920, a shift range of continuously variable transmission 500 is selected.

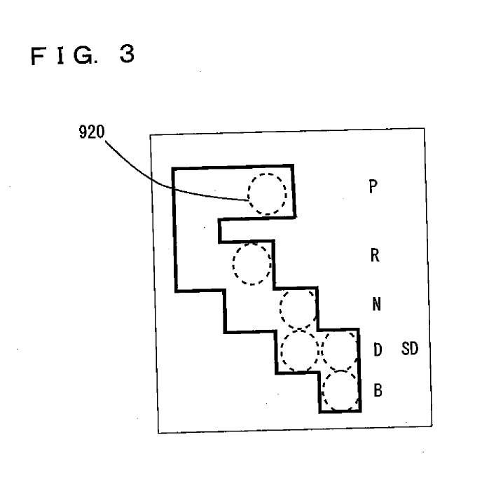

In the present embodiment, as shown in FIG. 3, shift lever 920 is moved along a shift gate. Depending on position PSH of shift lever 920, a shift range is selected from among a “P (parking)” range, an “R (reverse)” range, an “N (neutral)” range, a “D (drive)” range, an “SD (sports drive)” range, and a “B (brake)” range.

Referring back to FIG. 2, primary pulley revolution number sensor 922 detects a revolution number (an input shaft revolution number) NIN of primary pulley 504.

Secondary pulley revolution number sensor 924 detects a revolution number (an output shaft revolution number) NOUT of secondary pulley 508. A signal indicating a result of detection by each sensor is transmitted to ECU 900. Turbine revolution number NT matches with primary pulley revolution number NIN in forward drive in which forward clutch 406 is engaged. Vehicle speed V attains to a value corresponding to secondary pulley revolution number NOUT. Therefore, while the vehicle is at a standstill and forward clutch 406 is engaged, turbine revolution number NT is 0.

ECU 900 includes a CPU (Central Processing Unit), a memory, an input/output interface, and the like. The CPU performs signal processing in accordance with a program stored in the memory. Thus, control of output from engine 200, control of shift change of continuously variable transmission 500, control of a belt holding pressure, control of engagement/disengagement of forward clutch 406, control of engagement/disengagement of reverse brake 410, and the like are carried out.

Control of output from engine 200 is carried out by using an electronic throttle valve 1000, a fuel injection apparatus 1100, an ignition apparatus 1200, and the like. Control of shift change of continuously variable transmission 500, control of a belt holding pressure, control of engagement/disengagement of forward clutch 406, and control of engagement/disengagement of reverse brake 410 are carried out by a hydraulic control circuit 2000.

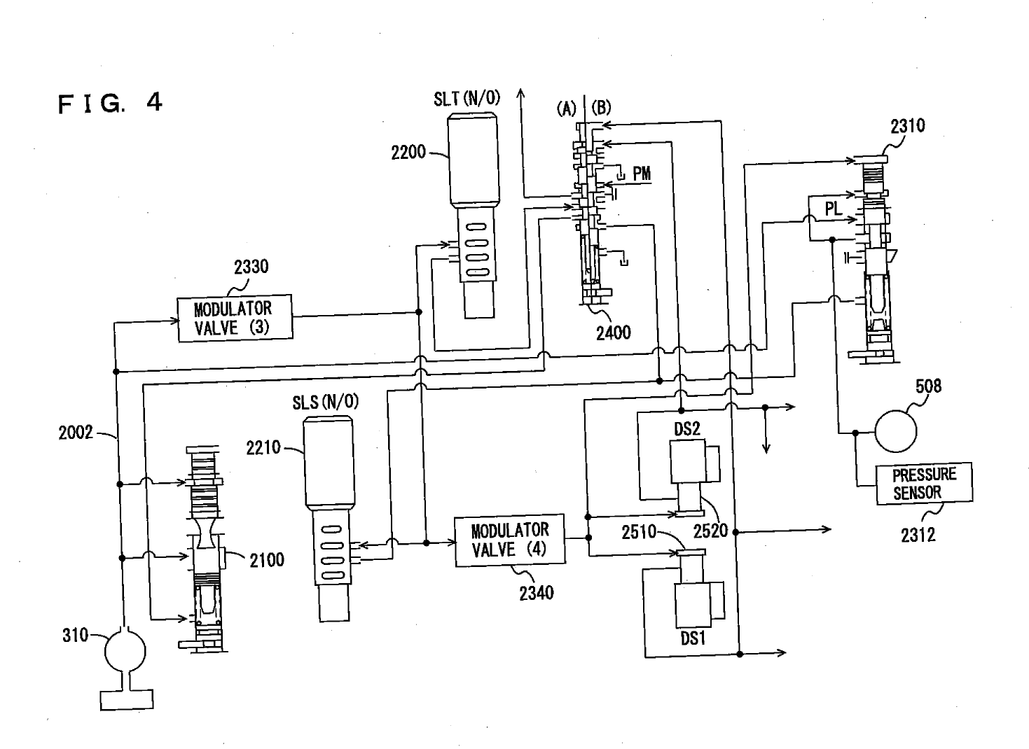

A part of hydraulic control circuit 2000 will be described with reference to FIG. 4. It is noted that hydraulic control circuit 2000 described below is merely by way of example and the hydraulic control circuit is not limited thereto.

A hydraulic oil pressure generated by oil pump 310 is supplied to a primary regulator valve 2100, a modulator valve (1) 2310, and a modulator valve (3) 2330 through a line pressure oil passage 2002.

Primary regulator valve 2100 is selectively supplied with a control pressure from any one of an SLT linear solenoid valve 2200 and an SLS linear solenoid valve 2210. In the present embodiment, both of SLT linear solenoid valve 2200 and SLS linear solenoid valve 2210 are solenoid valves that are normally open (in the absence of current feed, an output hydraulic oil pressure attains to maximum)). It is noted that SLT linear solenoid valve 2200 and SLS linear solenoid valve 2210 may normally be closed (in the absence of current feed, an output hydraulic oil pressure attains to minimum (“0”)).

A spool of primary regulator valve 2100 slides up and down in accordance with a supplied control pressure. Thus, a hydraulic oil pressure generated by oil pump 310 is regulated (adjusted) by primary regulator valve 2100. The hydraulic oil pressure regulated by primary regulator valve 2100 is adopted as a line pressure PL. In the present embodiment, as the control pressure supplied to primary regulator valve 2100 is higher, line pressure PL becomes higher. It is noted that line pressure PL may be lower as the control pressure supplied to primary regulator valve 2100 is higher.

A hydraulic oil pressure regulated by modulator valve (3) 2330 with line pressure PL serving as an original pressure is supplied to SLT linear solenoid valve 2200 and SLS linear solenoid valve 2210.

SLT linear solenoid valve 2200 and SLS linear solenoid valve 2210 generate a control pressure in accordance with a current value determined by a duty signal (a duty value) transmitted from ECU 900.

A control pressure to be supplied to primary regulator valve 2100 is selected from the control pressure (the output hydraulic oil pressure) from SLT linear solenoid valve 2200 and the control pressure (the output hydraulic oil pressure) from SLS linear solenoid valve 2210, by a control valve 2400.

When a spool of control valve 2400 is in a state shown with (A) in FIG. 4 (a state on the left), the control pressure is supplied from SLT linear solenoid valve 2200 to primary regulator valve 2100, Namely, line pressure PL is controlled in accordance with the control pressure of SLT linear solenoid valve 2200.

When the spool of control valve 2400 is in a state shown with (B) in FIG. 4 (a state on the right), the control pressure is supplied from SLS linear solenoid valve 2210 to primary regulator valve 2100. Namely, line pressure PL is controlled in accordance with the control pressure of SLS linear solenoid valve 2210.

When the spool of control valve 2400 is in the state shown with (B) in FIG. 4, the control pressure of SLT linear solenoid valve 2200 is supplied to a manual valve 2600 which will be described later.

The spool of control valve 2400 is biased in one direction by a spring. In order to cope with biasing force from the spring, a hydraulic oil pressure is supplied from a shift controlling duty solenoid (1) 2510 and a shift controlling duty solenoid (2) 2520.

Shift controlling duty solenoid (1) 2510 and shift controlling duty solenoid (2) 2520 output a hydraulic oil pressure (a control pressure) in accordance with a current value determined by a duty signal (a duty value) transmitted from ECU 900.

When the hydraulic oil pressure is supplied from both of shift controlling duty solenoid (1) 2510 and shift controlling duty solenoid (2) 2520 to control valve 2400, the spool of control valve 2400 is in the state shown with (B) in FIG. 4.

When the hydraulic oil pressure is not supplied from at least one of shift controlling duty solenoid (1) 2510 and shift controlling duty solenoid (2) 2520 to control valve 2400, the spool of control valve 2400 is in the state shown with (A) in FIG. 4, as a result of the biasing force from the spring.

The hydraulic oil pressure regulated by a modulator valve (4) 2340 is supplied to shift controlling duty solenoid (1) 2510 and shift controlling duty solenoid (2) 2520. Modulator valve (4) 2340 regulates the hydraulic oil pressure supplied from modulator valve (3) 2330 to a constant pressure.

Modulator valve (1) 2310 outputs the hydraulic oil pressure regulated with line pressure PL serving as the original pressure. The hydraulic oil pressure output from modulator valve (1) 2310 is supplied to the hydraulic cylinder of secondary pulley 508. Such a hydraulic oil pressure as not causing belt 510 to slip is supplied to the hydraulic cylinder of secondary pulley 508.

A spool movable in a direction of axis and a spring biasing the spool in one direction are provided in modulator valve (1) 2310. Modulator valve (1) 2310 regulates line pressure PL introduced in modulator valve (1) 2310, with the output hydraulic oil pressure from SLS linear solenoid valve 2210 of which duty is controlled by ECU 900 serving as a pilot pressure. The hydraulic oil pressure regulated by the modulator valve (3) is supplied to the hydraulic cylinder of secondary pulley 508. A belt holding pressure is increased or decreased in accordance with the hydraulic oil pressure output from modulator valve (1) 2310.

SLS linear solenoid valve 2210 is controlled such that a belt holding pressure not causing belt slip is attained, in accordance with a map including accelerator pedal opening angle ACC and gear ratio GR as parameters. Specifically, an exciting current for SLS linear solenoid valve 2210 is controlled at a duty ratio corresponding to the belt holding pressure. When transmitted torque suddenly changes at the time of acceleration, deceleration or the like, the belt holding pressure may be corrected to increase, so as to suppress belt slip.

The hydraulic oil pressure supplied to the hydraulic cylinder of secondary pulley 508 is detected by a pressure sensor 2312.

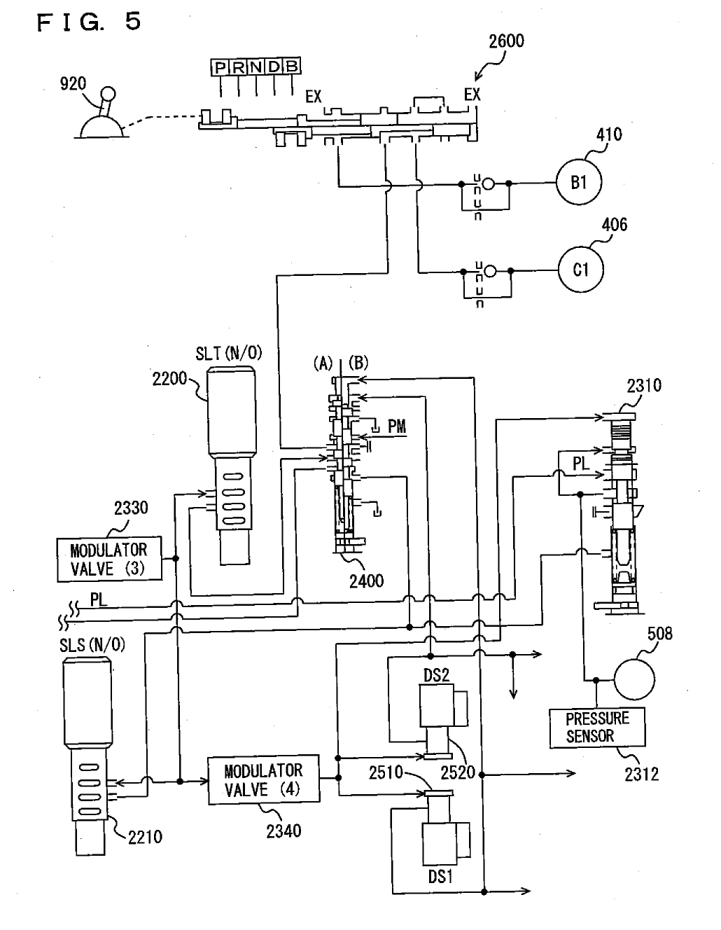

Manual valve 2600 will be described with reference to FIG. 5. Manual valve 2600 is mechanically switched in accordance with an operation of shift lever 920. Forward clutch 406 and reverse brake 410 are thus engaged or disengaged.

Shift lever 920 is operated to the “P” position for parking, the “R” position for backward drive, the “N” position for cutting off transmission of motive power, the “D” (“SD”) position for forward drive, and the “B” position.

At the “P” position and the “N” position, the hydraulic oil pressure in forward clutch 406 and reverse brake 410 is drained from manual valve 2600. Thus, forward clutch 406 and reverse brake 410 are disengaged.

At the “R” position, the hydraulic oil pressure is supplied from manual valve 2600 to reverse brake 410. Reverse brake 410 is thus engaged. On the other hand, the hydraulic oil pressure in forward clutch 406 is drained from manual valve 2600. Forward clutch 406 is thus disengaged.

When control valve 2400 is in a state shown with (A) in FIG. 5 (a state on the left), a modulator pressure PM supplied from a not-shown modulator valve (2) is supplied to manual valve 2600 through control valve 2400. This modulator pressure PM holds reverse brake 410 in the engaged state.

When control valve 2400 is in a state shown with (B) in FIG. 5 (a state on the right), the hydraulic oil pressure regulated by SLT linear solenoid valve 2200 is supplied to manual valve 2600. By regulating the hydraulic oil pressure using SLT linear solenoid valve 2200, reverse brake 410 is gradually engaged and shock at the time of engagement is suppressed.

Meanwhile, when the duty ratio of SLT linear solenoid valve 2200 is set to 100% and an amount of current feed is maximized while control valve 2400 is in the state shown with (B) in FIG. 5 (the state on the right), the hydraulic oil pressure is no longer output from SLT linear solenoid valve 2200 and the hydraulic oil pressure supplied to reverse brake 410 is set to “0”. Namely, the hydraulic oil pressure is drained from reverse brake 410 through SLT linear solenoid valve 2200 and hence reverse brake 410 is disengaged.

At the “D” (“SD”) position and the “B” position, the hydraulic oil pressure is supplied from manual valve 2600 to forward clutch 406. Forward clutch 406 is thus engaged. On the other hand, the hydraulic oil pressure in reverse brake 410 is drained from manual valve 2600. Reverse brake 410 is thus disengaged.

When control valve 2400 is in the state shown with (A) in FIG. 5 (the state on the left), modulator pressure PM supplied from the not-shown modulator valve (2) is supplied to manual valve 2600 through control valve 2400. This modulator pressure PM holds forward clutch 406 in the engaged state.

When control valve 2400 is in the state shown with (B) in FIG. 5 (the state on the right), the hydraulic oil pressure regulated by SLT linear solenoid valve 2200 is supplied to manual valve 2600. By regulating the hydraulic oil pressure using SLT linear solenoid valve 2200, forward clutch 406 is gradually engaged and shock at the time of engagement is suppressed.

SLT linear solenoid valve 2200 normally controls line pressure PL through control valve 2400. SLS linear solenoid valve 2210 normally controls the belt holding pressure through modulator valve (1) 2310.

On the other hand, when a condition for carrying out neutral control including such a condition that a vehicle has stopped (the vehicle speed has attained to “0”) while shift lever 920 is at the “D” (“SD”) position is satisfied, SLT linear solenoid valve 2200 controls engagement force of forward clutch 406 so as to lower the engagement force of forward clutch 406. SLS linear solenoid valve 2210 controls the belt holding pressure through modulator valve (1) 2310 and controls line pressure PL in place of SLT linear solenoid valve 2200.

When garage shift in which shift lever 920 is operated from the “N” position to the “D” position or the “R” position is performed, SLT linear solenoid valve 2200 controls the engagement force of forward clutch 406 or reverse brake 410 such that forward clutch 406 or reverse brake 410 is gradually engaged. SLS linear solenoid valve 2210 controls the belt holding pressure through modulator valve (1) 2310 and controls line pressure PL in place of SLT linear solenoid valve 2200.

When shift lever 920 is operated to the “R” position during forward drive of the vehicle (with the vehicle speed equal to or higher than a recovery speed (V(R)), SLT linear solenoid valve 2200 is controlled to disengage reverse brake 410.

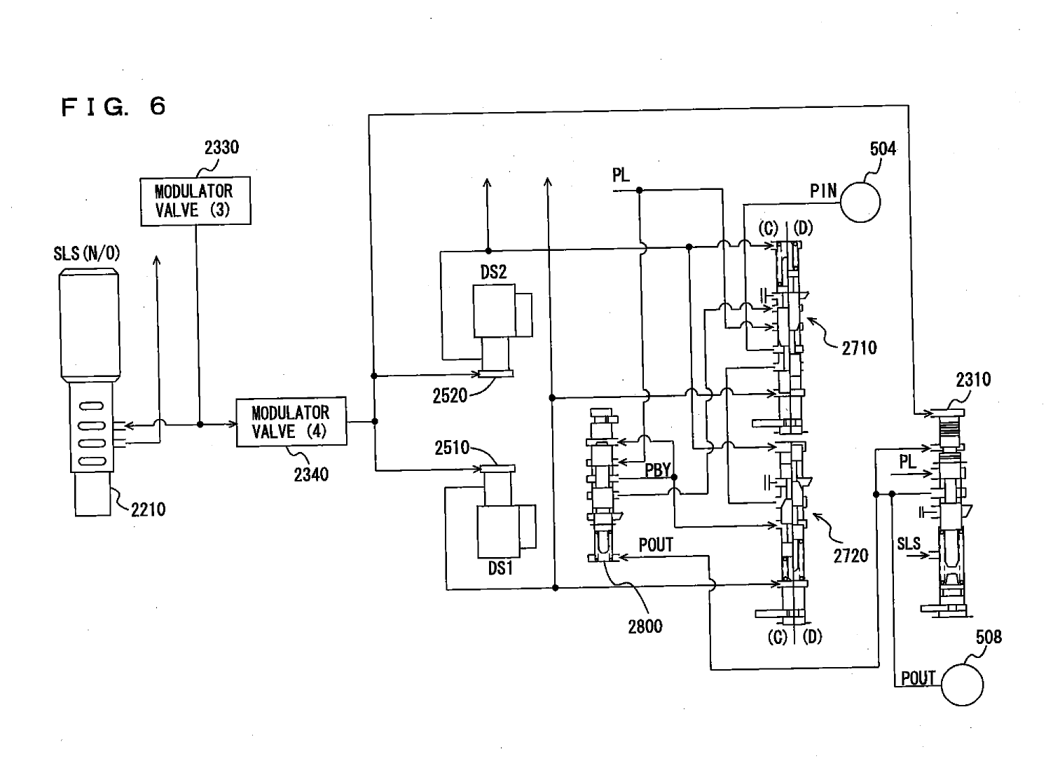

A configuration for controlling shift change will be described with reference to FIG. 6. Control of shift change is carried out by controlling supply and drain of a hydraulic oil pressure to the hydraulic cylinder of primary pulley 504. Supply and drain of the hydraulic oil to the hydraulic cylinder of primary pulley 504 is carried out by using a ratio control valve (1) 2710 and a ratio control valve (2) 2720.

Ratio control valve (1) 2710 supplied with line pressure PL and ratio control valve (2) 2720 connected to a drain are coupled to the hydraulic cylinder of primary pulley 504.

Ratio control valve (1) 2710 is a valve for up-shifting. Ratio control valve (1) 2710 is configured to open and close a flow path between an input port supplied with line pressure PL and an output port communicating with the hydraulic cylinder of primary pulley 504, by using a spool.

A spring is arranged at one end portion of the spool of ratio control valve (1) 2710. At an end portion opposite to the spring with the spool being interposed, a port supplied with a control pressure from shift controlling duty solenoid (1) 2510 is formed. In addition, at an end portion on the side where the spring is arranged, a port supplied with a control pressure from shift controlling duty solenoid (2) 2520 is formed.

By increasing the control pressure from shift controlling duty solenoid (1) 2510 and by not outputting the control pressure from shift controlling duty solenoid (2) 2520, the spool of ratio control valve (1) 2710 is in a state shown with (D) in FIG. 6 (a state on the right).

In this state, the hydraulic oil pressure supplied to the hydraulic cylinder of primary pulley 504 increases and a groove width of primary pulley 504 becomes narrower, and hence gear ratio GR lowers. Namely, up-shifting is carried out. In addition, by increasing a supply flow rate of the hydraulic oil at that time, a rate of shift change becomes greater.

Ratio control valve (2) 2720 is a valve for down-shifting. A spring is arranged at one end portion of the spool of ratio control valve (2) 2720. At an end portion on the side where the spring is arranged, a port supplied with a control pressure from shift controlling duty solenoid (1) 2510 is formed. At an end portion opposite to the spring with the spool being interposed, a port supplied with a control pressure from shift controlling duty solenoid (2) 2520 is formed.

By increasing the control pressure from shift controlling duty solenoid (2) 2520 and by not outputting the control pressure from shift controlling duty solenoid (1) 2510, the spool of ratio control valve (2) 2720 is in a state shown with (C) in FIG. 6 (a state on the left). At the same time, the spool of ratio control valve (1) 2710 is in the state shown with (C) in FIG. 6 (the state on the left).

In this state, the hydraulic oil is drained from the hydraulic cylinder of primary pulley 504 through ratio control valve (1) 2710 and ratio control valve (2) 2720. Therefore, a groove width of primary pulley 504 becomes wider, and consequently, gear ratio GR increases. Namely, down-shifting is carried out. In addition, by increasing a drain flow rate of the hydraulic oil at that time, a rate of shift change becomes greater.

In controlling gear ratio GR, the hydraulic oil pressure (the control pressure) output from shift controlling duty solenoid (1) 2510 and the hydraulic oil pressure (the control pressure) output from shift controlling duty solenoid (2) 2520 attain to values in accordance with duty values transmitted to the respective shift controlling duty solenoids from ECU 900.

In the present embodiment, as the duty value is higher, the control pressure of the shift controlling duty solenoid becomes higher. The duty value is determined based on a difference between an actual revolution number of input shaft 502 of continuously variable transmission 500 and a target revolution number NINT set in accordance with a map or the like which will be described later. As the difference between the actual revolution number of input shaft 502 and target revolution number NINT is greater, the higher duty ratio is set.

When force applied to the spool by the hydraulic oil pressure output from shift controlling duty solenoid (1) 2510 is smaller than the sum of force applied to the spool by the hydraulic oil pressure output from shift controlling duty solenoid (2) 2520 and the biasing force of the spring in ratio control valve (1) 2710, the spool of ratio control valve (1) 2710 is set to the state shown with (C) (the state on the left).

When force applied to the spool by the hydraulic oil pressure output from shift controlling duty solenoid (2) 2520 is smaller than the sum of force applied to the spool by the hydraulic oil pressure output from shift controlling duty solenoid (1) 2510 and the biasing force of the spring in ratio control valve (2) 2720, the spool of ratio control valve (2) 2720 is set to the state shown with (D) (the state on the right).

Therefore, by outputting a control pressure from neither shift controlling duty solenoid (1) 2510 nor ratio control valve (2) 2720, the spool of ratio control valve (1) 2710 is set to the state shown with (C) (the state on the left), and at the same time, the spool of ratio control valve (2) 2720 is set to the state shown with (D) (the state on the right).

In this state, the hydraulic oil pressure regulated by a bypass control valve 2800 connected to ratio control valve (2) 2720 is supplied to the hydraulic cylinder of primary pulley 504. Namely, a flow rate of the hydraulic oil supplied to the hydraulic cylinder of primary pulley 504 is controlled by bypass control valve 2800.

A spring is arranged at one end portion of a spool of bypass control valve 2800. This spring biases the spool in a direction of connection of an input port supplied with line pressure PL and an output port for outputting a hydraulic oil pressure (a hydraulic oil pressure regulated by bypass control valve 2800) PBY to finally be supplied to the hydraulic cylinder of primary pulley 504 to each other.

At an end portion on the side where the spring is arranged, a port supplied with an output hydraulic oil pressure POUT from modulator valve (1) 2310 is formed. At an end portion opposite to the spring with the spool being interposed, a feedback port to which hydraulic oil pressure POUT output from bypass control valve 2800 is fed back is formed.

Here, assuming a cross-sectional area of bypass control valve 2800 on the feedback port side as A(1), a cross-sectional area thereof on the side of a port supplied with hydraulic oil pressure POUT from modulator valve (1) 2310 as A(2), and biasing force of the spring as W, an equilibrium state is achieved in this bypass control valve 2800 as shown in the following equation.

PBY×A(1)=POUT×A(2)+W (1)

When this equation (1) is transformed, hydraulic oil pressure PBY output from bypass control valve 2800 is as follows.

PBY={A(2)/(A)1}×POUT+W/A(1) (2)

Namely, the hydraulic oil pressure expressed in the equation (2) having such a term as {A(2)/(A)1}×POUT is input to ratio control valve (2) 2720.

Therefore, when the spool of ratio control valve (1) 2710 is in the state shown with (C) (the state on the left) and the spool of ratio control valve (2) 2720 is in the state shown with (D) (the state on the right), a hydraulic oil pressure in accordance with hydraulic oil pressure POUT output for controlling a belt holding pressure can finally be supplied to the hydraulic cylinder of primary pulley 504.

When the hydraulic oil leaks from a hydraulic control circuit, a hydraulic control device or the like and the hydraulic oil pressure of the hydraulic cylinder of primary pulley 504 lowers, the hydraulic oil is supplied little by little to the hydraulic cylinder of primary pulley 504 from bypass control valve 2800. Therefore, a shift change state exhibits slightly up-shifting tendency. Namely, gradual up-shifting, in which gear ratio GR lowers little by little, is exhibited.

Gear ratio GR during a normal operation is controlled such that primary pulley revolution number NIN attains to target revolution number NINT set by using a map. Target revolution number NINT is set by using a map including vehicle speed V and accelerator pedal opening angle ACC as parameters.

A function of ECU 900 will be described with reference to FIG. 7. It is noted that the function described below may be achieved by software or hardware,

ECU 900 includes a setting unit 930, a restriction unit 932, a canceling unit 934, and a control unit 936. Setting unit 930 sets target revolution number NINT of primary pulley revolution number NlN in accordance with the map including vehicle speed V and accelerator pedal opening angle ACC as parameters.

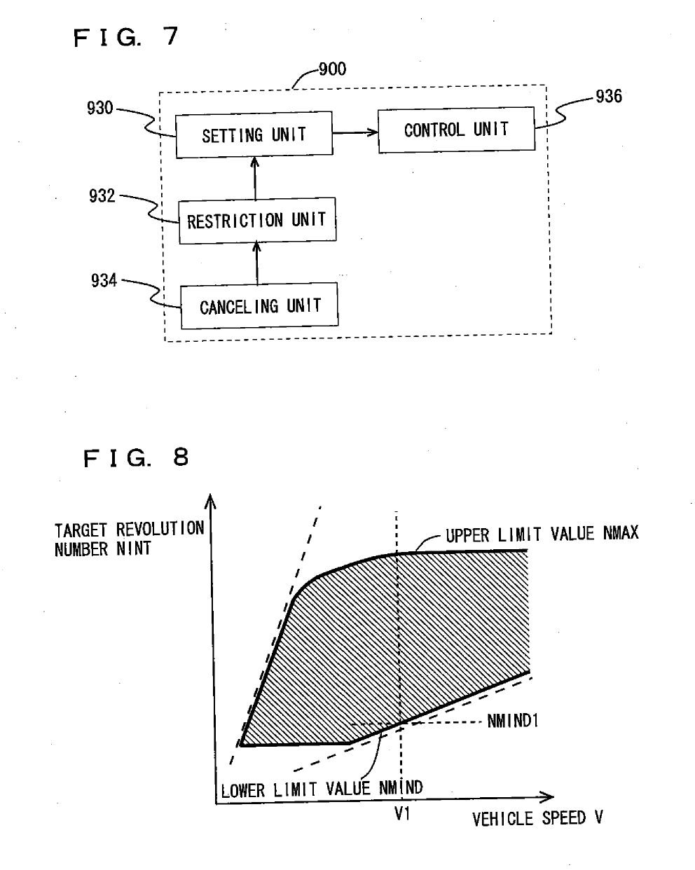

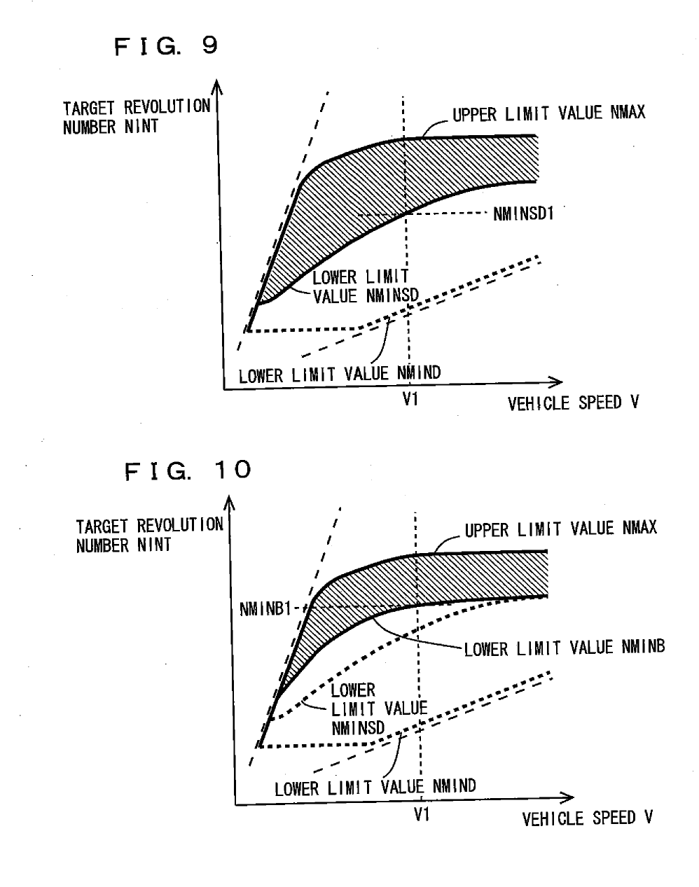

When the shift range is set to the “D” range, target revolution number NINT is set within a hatched region in FIG. 8. Namely, target revolution number NINT is set within a range equal to or lower than an upper limit value NMAX and equal to or higher than a lower limit value NMIND. Target revolution number NINT is set to be lower as accelerator pedal opening angle ACC is smaller. For example, when accelerator pedal opening angle ACC is equal to or smaller than a threshold value ACCOFF, target revolution number NINT is set to a lowest value. It is noted that, for example, a value at which the accelerator pedal opening angle can be regarded as zero is set as threshold value ACCOFF. As shown in FIG. 8, when vehicle speed V is “V1” and when accelerator pedal opening angle ACC is equal to or smaller than threshold value ACCOFF, “NMIND1” is set as target revolution number NINT. When the shift range is set to the “SD” range, target revolution number NINT is set within a hatched region in FIG. 9. Namely, target revolution number NINT is set within a range equal to or lower than upper limit value NMAX and equal to or higher than a lower limit value NMINSD. As shown in FIG. 8, lower limit value NMINSD for the “SD” range is higher than lower limit value NMIND for the “D” range.

As in the case of the “D” range, target revolution number NINT is set to be lower as accelerator pedal opening angle ACC is smaller. As shown in FIG. 9, when vehicle speed V is “V1” and when accelerator pedal opening angle ACC is equal to or smaller than threshold value ACCOFF, “NMENSD1” is set as target revolution number NINT.

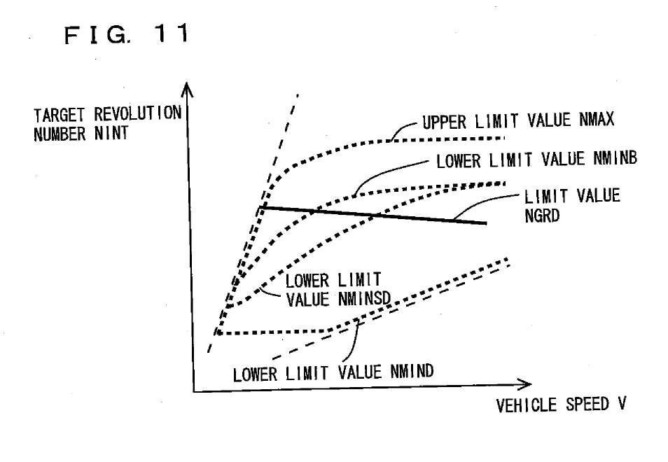

When the shift range is set to the “B” range, target revolution number NINT is set within a hatched region in FIG. 10. Namely, target revolution number NINT is set within a range equal to or lower than upper limit value NMAX and equal to or higher than a lower limit value NMINB. As shown in FIG. 10, lower limit value NMINB for the “B” range is higher than lower limit value NMINSD for the “SD” range and lower limit value NMIND for the “D” range.

As in the case of the “D” range and the “SD” range, target revolution number NINT is set to be lower as accelerator pedal opening angle ACC is smaller. As shown in FIG. 10, when vehicle speed V is “V1” and when accelerator pedal opening angle ACC is equal to or smaller than threshold value ACCOFF, “NMINB1” is set as target revolution number NINT.

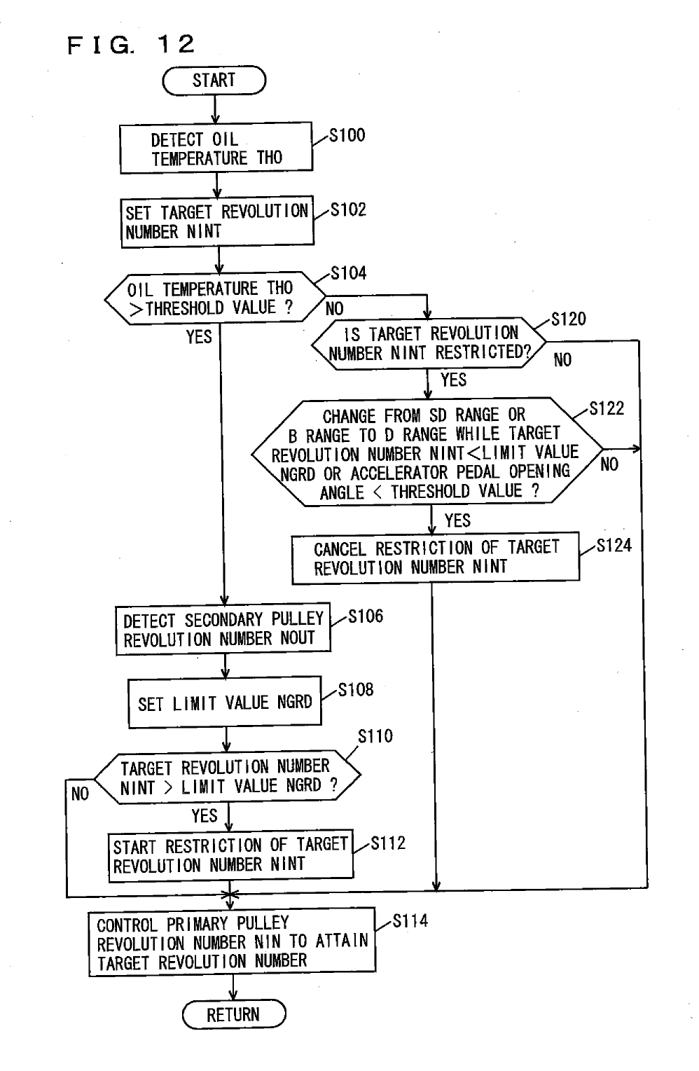

When a condition that oil temperature THO is higher than a threshold value THO1is satisfied, restriction unit 932 restricts target revolution number NINT to limit value NGRD or lower, which is determined in accordance with secondary pulley revolution number NOUT of continuously variable transmission 500. Limit value NGRD is set to be lower as secondary pulley revolution number NOUT is higher. As shown in FIG. 11, limit value NGRD is set to be higher than lower limit value NMIND for the, “D” range. It is noted that a constant value may be set as limit value NGRD.

When target revolution number NINT set by using the map including vehicle speed V and accelerator pedal opening angle ACC as the parameters is equal to or higher than limit value NGRD, limit value NGRD is set as target revolution number NINT. When target revolution number NINT set by using the map is lower than limit value NGRD, target revolution number HINT set by using the map is employed. When a condition that oil temperature THO is equal to or lower than threshold value THO1 and target revolution number NINT set by using the map including vehicle speed V and accelerator pedal opening angle ACC as the parameters is lower than limit value NGRD is satisfied, canceling unit 934 cancels restriction of target revolution number NINT to limit value NGRD or lower. Namely, after the condition that oil temperature THO is equal to or lower than threshold value THO1and target revolution number NINT set by using the map including vehicle speed V and accelerator pedal opening angle ACC as the parameters is lower than limit value NGRD is satisfied, target revolution number NINT is permitted to become greater than limit value NGRD.

In addition, when the condition that oil temperature THO is equal to or lower than threshold value THO1 and the shift range was changed from the “SD” range or the “B” range to the “D” range while accelerator pedal opening angle ACC is equal to or smaller than threshold value ACCOFF is satisfied, canceling unit 934 cancels restriction of target revolution number NINT to limit value NGRD or lower. Namely, after the condition that oil temperature THO is equal to or lower than the threshold value and the shift range was changed from the “SD” range or the “B” range to the “D” range while accelerator pedal opening angle ACC is equal to or smaller than threshold value ACCOFF is satisfied, target revolution number NINT is permitted to become greater than limit value NGRD.

Control unit 936 controls gear ratio GR of continuously variable transmission 500 such that primary pulley revolution number NIN attains to target revolution number NINT.

A control structure of a program executed by ECU 900 serving as the control device according to the present embodiment will be described with reference to FIG. 12. It is noted that the program executed by ECU 900 may be distributed in markets as recorded on a recording medium such as a CD (Compact Disc), a DVD (Digital Versatile Disc), and the like.

In step (hereinafter step is abbreviated as S) 100, ECU 900 detects oil temperature THO based on a signal transmitted from oil temperature sensor 912.

In S102, ECU 900 sets target revolution number NINT of primary pulley revolution number NUN based on the map including vehicle speed V and accelerator pedal opening angle ACC as the parameters.

In S104, ECU 900 determines whether oil temperature THO is higher than the threshold value or not. When oil temperature THO is higher than the threshold value (YES in S104), the process proceeds to S106. Otherwise (NO in S104), the process proceeds to S120.

In S106, ECU 900 detects secondary pulley revolution number NOUT based on a signal transmitted from secondary pulley revolution number sensor 924. In S108, ECU 900 sets limit value NGRD of target revolution number NINT in accordance with secondary pulley revolution number NOUT. In the present embodiment, limit value NGRD is set to be lower as secondary pulley revolution number NOUT is higher.

In S110, ECU 900 determines whether target revolution number NINT set by using the map is higher than limit value NGRD or not. When target revolution number NINT set by using the map is higher than limit value NGRD (YES in S110), the process proceeds to S112. Otherwise (NO in S110), the process proceeds to S114.

In S112, ECU 900 starts restriction of target revolution number NINT to limit value NGRD or lower. When target revolution number NINT has already been restricted to limit value NGRD or lower, restriction of target revolution number NINT to limit value NGRD or lower is continued.

In S114, ECU 900 controls primary pulley revolution number NIN to attain target revolution number NINT.

In S120, ECU 900 determines whether or not target revolution number NINT of primary pulley revolution number NIN is restricted to limit value NGRD or lower. When target revolution number NINT of primary pulley revolution number NIN is restricted to limit value NGRD or lower (YES in S120), the process proceeds to S122. Otherwise (NO in S120), the process proceeds to S114.

In S122, ECU 900 determines whether the condition that target revolution number NINT set by using the map is lower than limit value NGRD or the condition that the shift range was changed from the “SD” range or the “B” range to the “D” range while accelerator pedal opening angle ACC is equal to or smaller than threshold value ACCOFF is satisfied or not. When the condition that target revolution number NINT set by using the map is lower than limit value NGRD or the condition that the shift range was changed from the “SD” range or the “B” range to the “D” range while accelerator pedal opening angle ACC is equal to or smaller than threshold value ACCOFF is satisfied (YES in S122), the process proceeds to S124. Otherwise (NO in S122), the process proceeds to S114.

In S124, ECU 900 cancels restriction of target revolution number NINT to limit value NGRD or lower.

An operation of the control device according to the present embodiment based on the structure and the flowchart as above will now be described.

While the vehicle runs, oil temperature THO is detected based on the signal transmitted from oil temperature sensor 912 (S100). In addition, target revolution number NINT of primary pulley revolution number NIN is set based on the map including vehicle speed V and accelerator pedal opening angle ACC as the parameters (S102).

When oil temperature THO is higher than the threshold value (YES in S104), secondary pulley revolution number NOUT is detected (S106) and limit value NGRD of target revolution number NINT of primary pulley revolution number MN is set in accordance with secondary pulley revolution number NOUT (S108). Limit value NGRD is set to be lower as secondary pulley revolution number NOUT is higher.

When target revolution number NINT set by using the map is equal to or lower than limit value NGRD (NO in S110), primary pulley revolution number MN is controlled to attain target revolution number NINT set by using the map (S114).

On the other hand, when target revolution number NINT set by using the map is higher than limit value NGRD (YES in S110), restriction of target revolution number NINT to limit value NGRD or lower is started (S112) and primary pulley revolution number NIN is controlled to attain target revolution number NINT (S114). Namely, primary pulley revolution number NIN is controlled to attain limit value NGRD.

Thus, primary pulley revolution number NIN can be controlled in accordance with secondary pulley revolution number NOUT affecting an amount of heat generation in continuously variable transmission 500. In the present embodiment, in an operation state where an amount of heat generation in continuously variable transmission 500 tends to be great because of high secondary pulley revolution number NOUT, for example by lowering primary pulley revolution number MN by up-shifting, the amount of heat generation can be restricted. Therefore, the temperature of the hydraulic oil used for actuation of continuously variable transmission 500 can be maintained in an appropriate state.

When oil temperature THO is equal to or lower than the threshold value (NO in S104), whether or not target revolution number NINT of primary pulley revolution number MN is restricted to limit value NGRD or lower is determined (S120).

When target revolution number NINT of primary pulley revolution number NIN is restricted to limit value NGRD or lower (YES in S120), whether or not the condition that target revolution number NINT set by using the map is lower than limit value NGRD or the condition that the shift range was changed from the “SD” range or the “B” range to the “D” range while accelerator pedal opening angle ACC is equal to or smaller than threshold value ACCOFF is satisfied is determined (S122).

When the condition that target revolution number NINT set by using the map is lower than limit value NGRD is satisfied (YES in S122), restriction of target revolution number NINT to limit value NGRD or lower is canceled (S124).

Thus, while target revolution number NINT is lower than limit value NGRD, restriction of target revolution number NINT to limit value NGRD or lower can be canceled. Therefore, target revolution number NINT immediately before cancellation of restriction of target revolution number NINT to limit value NGRD or lower can substantially be equal to target revolution number NINT immediately after cancellation. Therefore, restriction of target revolution number NINT to limit value NGRD or lower can be canceled without down-shifting. Consequently, driver's uncomfortable feeling can be lessened.

Meanwhile, when the condition that the shift range was changed from the “SD” range or the “B” range to the “D” range while accelerator pedal opening angle ACC is equal to or smaller than threshold value ACCOFF is satisfied (YES in S122), restriction of target revolution number NINT to limit value NGRD or lower is canceled (S124),

In this case as well, restriction of target revolution number NINT to limit value NGRD or lower can be canceled without down-shifting. Therefore, driver's uncomfortable feeling can be lessened.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. (canceled)

2. (Canceled)

3. A control device for a continuously variable transmission controlled in a manner defined for each of a plurality of shift ranges in a vehicle provided with an accelerator pedal, comprising:
an accelerator pedal opening angle detection unit that detects an accelerator pedal opening angle;
a selection unit that selects a shift range of said continuously variable transmission;
a first setting unit that sets a target input shaft revolution number of said continuously variable transmission to be lower as the accelerator pedal opening angle is smaller within a range equal to or higher than a first lower limit value when a first shift range is selected;
a second setting unit that sets said target input shaft revolution number within a range equal to or higher than a second lower limit value higher than said first lower limit value when a second shift range is selected;
a restriction unit that restricts said target input shaft revolution number to a predetermined limit value or lower;
a control unit that controls an input shaft revolution number of said continuously variable transmission to attain said target input shaft revolution number; and
a canceling unit that cancels restriction of said target input shaft revolution number to said limit value or lower when a condition that the shift range was changed from said second shift range to said first shift range is satisfied while the accelerator pedal opening angle is equal to or smaller than a predetermined value, wherein
said first setting unit sets said target input shaft revolution number to be lower than said limit value when the accelerator pedal opening angle is equal to or smaller than said predetermined value.

4. The control device for a continuously variable transmission according to claim 3, further comprising a temperature detection unit that detects a temperature of a hydraulic oil supplied to said continuously variable transmission, wherein
when a condition that the temperature of said hydraulic oil is higher than a threshold value is satisfied, said restriction unit restricts said target input shaft revolution number to said limit value or lower, and
when a condition that the temperature of said hydraulic oil is equal to or lower than said threshold value in addition to the condition that the shift range was changed from said second shift range to said first shift range while the accelerator pedal opening angle is equal to or smaller than said predetermined value is satisfied, said canceling unit cancels restriction of said target input shaft revolution number to said limit value or lower.

5. (canceled)

6. A control method for a continuously variable transmission controlled in a manner defined for each of a plurality of shift ranges in a vehicle provided with an accelerator pedal, comprising the steps of:
detecting an accelerator pedal opening angle;
selecting a shift range of said continuously variable transmission;
setting a target input shaft revolution number of said continuously variable transmission to be lower as the accelerator pedal opening angle is smaller within a range equal to or higher than a first lower limit value when a first shift range is selected;
setting said target input shaft revolution number within a range equal to or higher than a second lower limit value higher than said first lower limit value when a second shift range is selected;
restricting said target input shaft revolution number to a predetermined limit value or lower;
controlling an input shaft revolution number of said continuously variable transmission to attain said target input shaft revolution number; and
canceling restriction of said target input shaft revolution number to said limit value or lower when a condition that the shift range was changed from said second shift range to said first shift range is satisfied while the accelerator pedal opening angle is equal to or smaller than a predetermined value, wherein
said step of setting a target input shaft revolution number of said continuously variable transmission to be lower as the accelerator pedal opening angle is smaller within a range equal to or higher than a first lower limit value includes the step of setting said target input shaft revolution number to be lower than said limit value when the accelerator pedal opening angle is equal to or smaller than said predetermined value.

7. (canceled)

8. A control device for a continuously variable transmission controlled in a manner defined for each of a plurality of shift ranges in a vehicle provided with an accelerator pedal, comprising:
means for detecting an accelerator pedal opening angle;
means for selecting a shift range of said continuously variable transmission;
first setting means for setting a target input shaft revolution number of said continuously variable transmission to be lower as the accelerator pedal opening angle is smaller within a range equal to or higher than a first lower limit value when a first shift range is selected;
second setting means for setting said target input shaft revolution number within a range equal to or higher than a second lower limit value higher than said first lower limit value when a second shift range is selected;
restriction means for restricting said target input shaft revolution number to a predetermined limit value or lower;
means for controlling an input shaft revolution number of said continuously variable transmission to attain said target input shaft revolution number; and
canceling means for canceling restriction of said target input shaft revolution number to said limit value or lower when a condition that the shift range was changed from said second shift range to said first shift range is satisfied while the accelerator pedal opening angle is equal to or smaller than a predetermined value, wherein said first setting means includes means for setting said target input shaft revolution number to be lower than said limit value when the accelerator pedal opening angle is equal to or smaller than said predetermined value.

9. The control device for a continuously variable transmission according to claim 3, wherein
said canceling unit includes a canceling unit that cancels restriction of said target input shaft revolution number to said limit value or lower when the condition that the shift range was changed from said second shift range to said first shift range while the accelerator pedal opening angle is equal to or smaller than the predetermined value or a condition that said target input shaft revolution number is lower than said limit value is satisfied.

10. The control method for a continuously variable transmission according to claim 6, wherein
said step of canceling restriction of said target input shaft revolution number to said limit value or lower includes the step of canceling restriction of said target input shaft revolution number to said limit value or lower when the condition that the shift range was changed from said second shift range to said first shift range while the accelerator pedal opening angle is equal to or smaller than the predetermined value or a condition that said target input shaft revolution number is lower than said limit value is satisfied.

11. The control device for a continuously variable transmission according to claim 8, wherein
said canceling means includes canceling means for canceling restriction of said target input shaft revolution number to said limit value or lower when the condition that the shift range was changed from said second shift range to said first shift range while the accelerator pedal opening angle is equal to or smaller than the predetermined value or a condition that said target input shaft revolution number is lower than said limit value is satisfied.
